(19) United States
(12) Patent Application Publication
(10) Pub. No.: US 2011/0023750 A1
(43) Pub. Date: Feb. 3, 2011

(54) INK COMPOSITION FOR FORMING ABSORBERS OF THIN FILM CELLS AND PRODUCING METHOD THEREOF

(75) Inventor: Chi-Jane WANG, Tainan City (TW)

Correspondence Address: Ching-Ling Huang, 5597 NW 127th Ter, Portland, OR, 97229, US

(73) Assignee: Kuan-Che WANG, Tainan City (TW)

(21) Appl. No.: 12/510,275

(22) Filed: Jul. 28, 2009

(51) Int. Cl. C09D 11/02

(52) U.S. Cl. 106/31.13

(57) ABSTRACT

An ink composition for forming absorbers of thin film cells comprising particles and a chelating agent for the particles. The particles contain a mixture of at least one element or the salts from group IB and/or IIIA and/or VIA. In the present invention, the chelating agent can alternatively be aromatic diamine compounds, alkyl diamine compounds or aliphatic diamine compounds. In addition, the present invention discloses a producing method for the ink composition as well. According to the present invention, the particles can be reacted into a single composition while the existence of the chelating agent, manufacturing the CIGS/CIS films in large scale and simplifying the conventional manufacturing processes are capable of accomplishment.

### FIELD OF THE INVENTION

The present invention relates to a method for preparing thin films of semiconductors for photovoltaic applications and more particularly preparing Group IB IIIA VIA thin films for thin film solar cells.

### BACKGROUND OF THE INVENTION

Solar cells are sorts of photovoltaic devices converting sunlight to usable electrical power. Because of improvement in conversion efficiency of cells and reduction of costs for manufacturing products in commercial scale, the interest in solar cells has obviously expended in recent years. The most common material applied into the solar cells is silicon, which is in form of a single or polycrystalline thick wafer. However, although the silicon-based solar cells hold the high conversion efficiency over 20%, a significant level of thickness to absorb the sunlight has been retained so that the decrease of manufacturing cost and the expansion of application on irregular surface are restricted.

Another type of solar cells, namely the “thin-film”, distinguished from the silicon-based cells has been developed rapidly due to the lower material cost and the competitive conversion efficiency. The typical structure of a thin-film solar cell essentially includes a substrate, a back contact layer, a p-type semiconductor absorber layer, an n-type junction buffer layer, and a transparent layer. Presently, one of the most potential absorber layer applied in thin-film solar cells uses a copper indium diselenide (CuInSe2, CIS) compound or the variants copper indium gallium diselenide (Cu(In, Ga)Se2, CIGS) and any of these compounds with sulfur replacing the selenium. CIGS or CIS cells have demonstrated the highest efficiency and good stability as comparing with other absorber layer compounds. Sometimes, the acronym CIS and CIGS have been in common use in literature, so CIGS is used here in an expanded meaning to represent the entire group of CIS based alloys.

To make an absorber layer using CIGS, one of the conventional techniques is that yielded high-quality CIGS layer for solar cell fabrication was co-evaporation of Cu, In, Ga and Se onto a heated substrate in a vacuum. Another technique is a two-stage process that after formation of Cu, In and Ga films on a substrate by means of sputtering or vapor deposition selenization method under Se or H2Se is reacted with the precursor at elevated temperature. Among them, although the vacuum deposition has an advantage of making a high efficient absorption layer, it shows low material utilization when making a large-sized absorption layer and also needs expensive equipment. Besides, hydrogen selenide is the most commonly used selenium bearing gas, which is extremely toxic to humans and requires great care in its use.

On account of the disadvantages of the vacuum deposition, methods for formation of CIGS layers using printing processes to coat an ink containing a metal oxide mixture particles on a substrate at a high temperature are now proposed, which allow one to make a large-sized absorption layer uniformly and reduce production costs in manufacturing solar cells, but because the metal oxide precursor is very stable chemically and thermally to form large crystals, the low efficiency of the absorption layer could be shown.

In addition, regarding the conversion efficiency of CIGS cells, the band gaps of CIGS layer verify continuously from 1.0 (for copper indium selenide) to 1.7 eV (for copper gallium selenide). The band gap can be controlled by altering Ga doping concentrations, and in order to obtain the proper band gap energy, the doping process should be carried out with the compositional ratio of Ga/(In+Ga) ranged from 0.3 to 0.6. If Cu/(In+Ga) ratio is less than 1, a Cu-poor signal chalcopyrite phase which has poor performance due to a small grain size is generated. On the other hand, when Cu/(In+Ga) ratio is more than 1, the grain size is increased and results in improved performance. But, in a Cu-rich phase, there are disadvantages that Cu2Se impurities are generated and derive a decrease in the light conversion efficiency caused by higher conductivity of Cu2Se.

### SUMMARY OF THE INVENTION

Accordingly, the primary object of the present invention is to solve the aforesaid disadvantages by providing an ink composition to simplify the process of forming CIGS/CIS thin film for solar cells by only a printing process.

Another object of the present invention is to provide an ink composition comprising at least any one of groups IB, IIIA and VIA in which the compositional ratios of Cu/(In+Ga) and Ga/(In+Ga) are freely regulated.

To achieve foregoing and other objects, the present invention provides an ink composition for forming absorbers of thin film cells comprising particles and a chelating agent for the particles. The particles contain a mixture of at least one element or the salts from group IB and/or IIIA and/or VIA. The chelating agent can be aromatic diamine compounds, alkyl diamine compounds or aliphatic diamine compounds. In addition, the ink composition comprises alcoholic compounds, such as methanol, ethanol, propanol, butanol, and tert-butanol.

Furthermore, the present invention provides a method for producing the aforesaid ink composition for forming absorbers of thin film cells. The method comprises the steps of:
a) obtaining powders containing a particle mixture of at least one elements or the salts from group IB and/or IIIA and/or VIA;
b) adding a chelating agent into the powders, the chelating agent is selected from the group consisting of aromatic diamine compounds, alkyl diamine compounds and aliphatic diamine compounds; and
c) heating the chelating agent to a first temperature at which the chelating agent is melted, and reacting the melting chelating agent with the powders in an inert gas environment to form solutions.

In one aspect, other steps of cooling the solutions to a second temperature which is lower than the first melting temperature and allows the solutions being stirred and mixing the cooled solutions with alcoholic compounds at the second temperature are included.

According to the ink composition for forming absorbers of thin film cells and the producing method set forth above, CIGS/CIS thin film can be formed by only a simple coating and printing process without requirement of alternative vacuum processing or complex equipment. Particularly, the method is applied in a single-stage process instead of the conventional multiple-stage process so that reduction of manufacturing costs is capable of accomplishment. Besides, the present invention can obtain advantages in both of the cases that the compositional ratio of Cu/(In+Ga) is more or less than 1 according to the possibility of free regulation of the compositional ratios of Cu/(In+Ga) and Ga/(In+Ga).

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 shows the X-ray diffraction (XRD) pattern of a CuIn1-xGaxSe2 powder formed in the embodiment I of the present invention.

FIG. 2 shows the X-ray diffraction (XRD) pattern of a CuInSe2 powder formed in the embodiment II of the present invention.

FIG. 3 shows the X-ray diffraction (XRD) pattern of a CuIn1-xGaxSe2 powder formed in the embodiment III of the present invention.

FIG. 4 shows the TEM image of a CuIn1-xGaxSe2 powder formed in the embodiment I of the present invention.

FIG. 5 shows the TEM image of a CuInSe2 powder formed in the embodiment II of the present invention.

FIG. 6 shows the TEM image of a CuIn1-xGaxSe2 powder formed in the embodiment III of the present invention.

### DETAILED DESCRIPTION OF THE PREFERRED EMBODIMENTS

The present invention discloses an ink composition for forming absorbers of thin film cells comprising particles and a chelating agent for the particles. The particles contain a mixture of at least one element from group IB and/or IIIA and/or VIA. The IB group elements include copper, silver and gold. The IIIA group elements include aluminum, gallium, indium and thallium. And the VIB group element is selenium. In the present invention, the particles can also alternatively include the salts of groups IB, IIIA and VIA, such as CuCl, InCl3, GaCl3, CuBr, InBr3, GaBr3, CuI, InI3 and GaI3. The chelating agent is selected from the group consisting of aromatic diamine compounds, alkyl diamine compounds and aliphatic diamine compounds. The aromatic diamine compounds include phenylenediamine, diaminotoluene, xylenediamine, 2,4-diethyltoluenediamine, 2,6-diethyltoluenediamine, diaminonaphthalene, diaminophenanthrene or diaminoanthracene. The alkyl diamine compounds include hexanediamine, heptanediamine and octanediamine. The aliphatic diamine compound is isophoronediamine. In addition, the ink composition further comprises alcoholic compounds selected from a group consisting of methanol, ethanol, propanol, butanol, and tert-butanol.

The present invention further provides a method for producing the ink composition forming absorbers of thin film cells. The method includes the steps as follow:
a) obtaining powders containing a particle mixture of at least one elements or the salts from group IB and/or IIIA and/or VIA;
b) adding a chelating agent into the powders, the chelating agent is selected from the group consisting of aromatic diamine compounds, alkyl diamine compounds and aliphatic diamine compounds; and
c) heating the chelating agent to a first temperature at which the chelating agent is melted, and reacting the melting chelating agent with the powders in an inert gas environment to form solutions.

Wherein, other steps of cooling the solutions to a second temperature which is lower than the first melting temperature and allows the solutions being stirred and mixing the cooled solutions with alcoholic compounds at the second temperature are included. And the inert gas can be nitrogen or argon.

### Embodiment I

This embodiment provides a producing method of an ink composition as follow: first, preparing a 500 ml glass reactor with a magnetic stirrer under the atmosphere of N2 for 30 minutes; adding 250 g m-phenylenediamine powders into the glass reactor with 18 g copper metal powders, 27 g indium powers, 5.2 g gallium and 51 g selenium powders (all the elements are in 99.99% purity), wherein the gallium were preheated at the temperature of 40-50° C. for 30 minutes to the melting state before dropping into the reactor; heating the reactor to the temperature of 180° C. for 1 hour when m-phenylenediamine melts to the liquid state; stirring the mixture of m-phenylenediamine, copper, indium, gallium and selenium, and reheating the glass reactor at the temperature of 240-260° C. for 48 hours. Then the reactor is cooled down to the temperature of 170° C., and 100 ml ethanol (99%) is dropped into the cooled reactor and boils for 2 hours. Finally, after quenching to room temperature, black liquid products are generated.

The black liquid products are smeared on a glass substrate by a dropper. The black liquid layer on the glass substrate is heated at the temperature of 200° C. holding for 1 hour under the pressure of 0.1 torr to obtain a precursor film. The precursor film formed on the substrate is heated again at the temperature of 400-450° C. for 1 hour to produce a dense film which smears on a molybdenum-substrate to form an absorption layer.

On the other hand, the black liquid products are alternatively transferred into a filter (Whatman#2) and washed with 2000 ml ethanol and 2000 ml acetone. Then dry the black liquid products at the temperature of 60° C. for 12 hours to get the final products, 100 g black CIGS powders.

### Embodiment II

The present invention also provides a second embodiment for producing an ink composition.

Initially, preparing a 500 ml glass reactor with a magnetic stirrer under the atmosphere of N2 for 30 minutes; adding 250 g hexanediamine into the glass reactor with 25.46 g copper metal powders, 46 g indium and 67 g selenium powders (all the elements are in 99.99% purity), wherein the hexanediamine were preheated at the temperature of 40-50° C. for 30 minutes to the melting type before adding into the reactor; heating the reactor to the temperature of 200-210° C. for 48 hours. Then the reactor is cooled down to the temperature of 120° C., and 100 ml ethanol (99%) is dropped into the cooled reactor and boils for 2 hours. Finally, after quenching to room temperature, black liquid products are generated.

The black liquid products are transferred into a filter (Whatman#2) and washed with 2500 ml ethanol and 2500 ml acetone. Then dry the black liquid products at the temperature of 60° C. for 12 hours to get the final products, 150 g black CIS nanopowders.

### Embodiment III

The present invention also provides a third embodiment for producing an ink composition.

Initially, preparing a 250 ml glass reactor with a magnetic stirrer under the atmosphere of N2 for 30 minutes; adding 50 g isophoronediamine into the glass reactor with 4.5 g copper metal powders, 6.7 g indium, 1.3 g gallium and 12.8 g selenium powders (all the elements are in 99.99% purity), wherein the gallium were preheated at the temperature of 40-50° C. for 30 minutes to the melting state before dropping into the reactor; stirring the mixture in the glass reactor and heating the glass reactor at the temperature of 230-240° C. for 48 hours. Then the reactor is cooled down to the temperature of 30° C., and 50 ml ethanol (99%) is dropped into the cooled reactor and stirs for 2 hours. Then, black liquid products are generated.

The black liquid products are transferred into a filter (Whatman#2) and washed with 500 ml ethanol, 1000 ml water and 500 ml acetone. Then dry the black liquid products at the temperature of 60° C. for 12 hours to get the final products, 22 g black CIGS nanopowders.

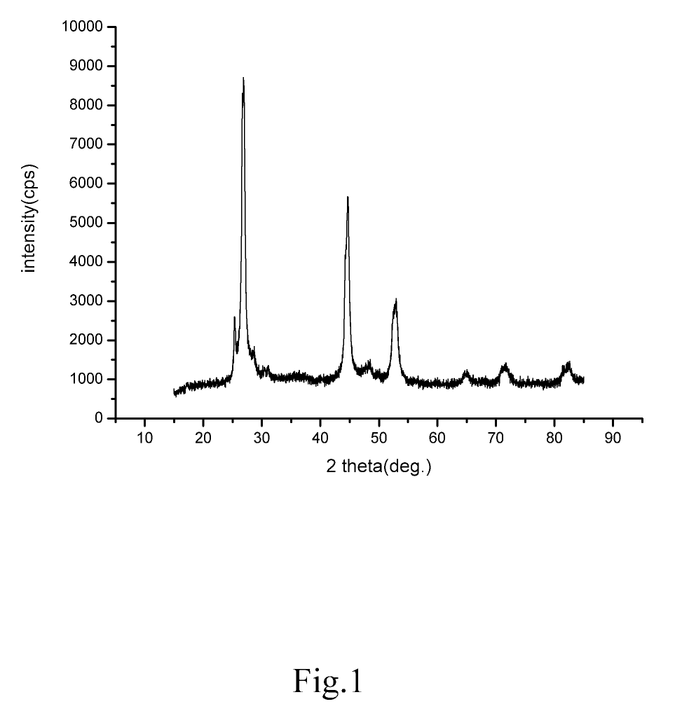

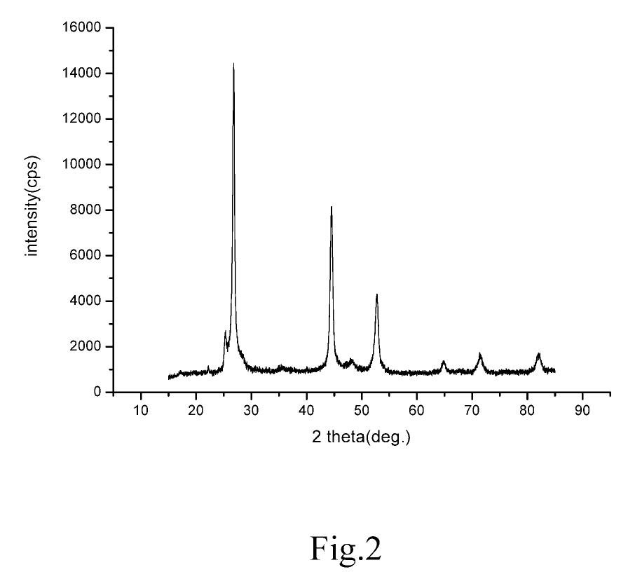

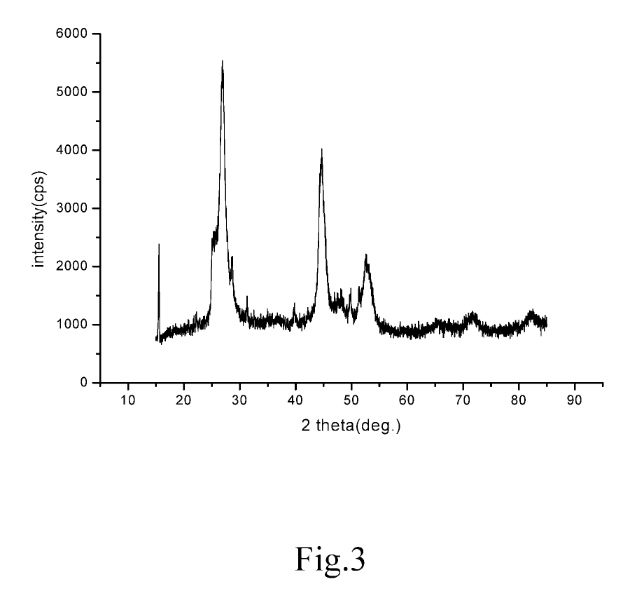

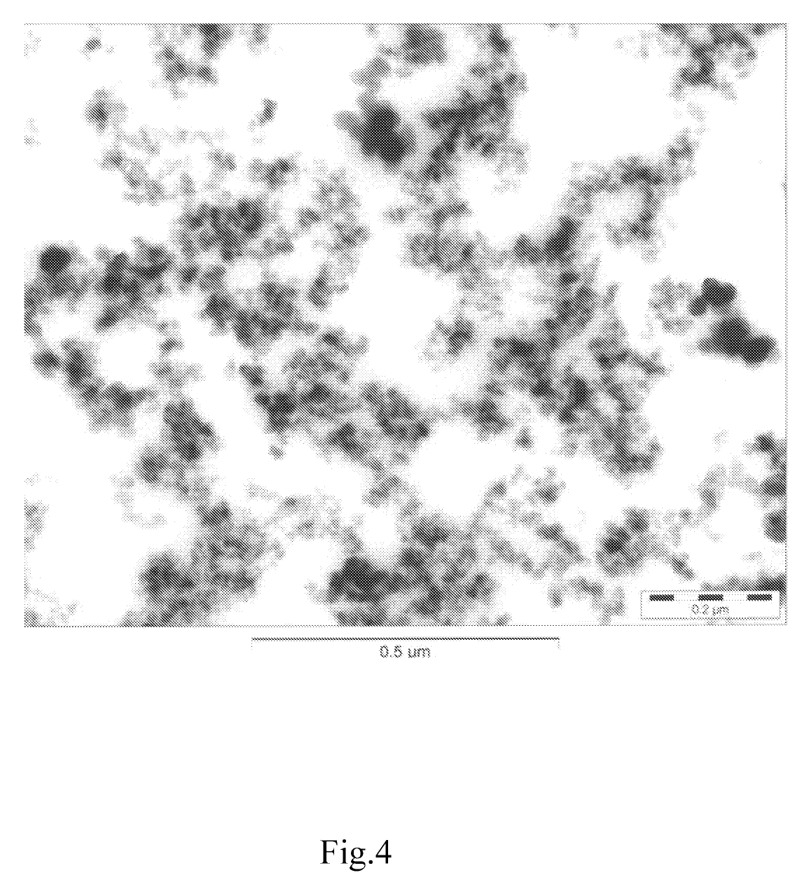

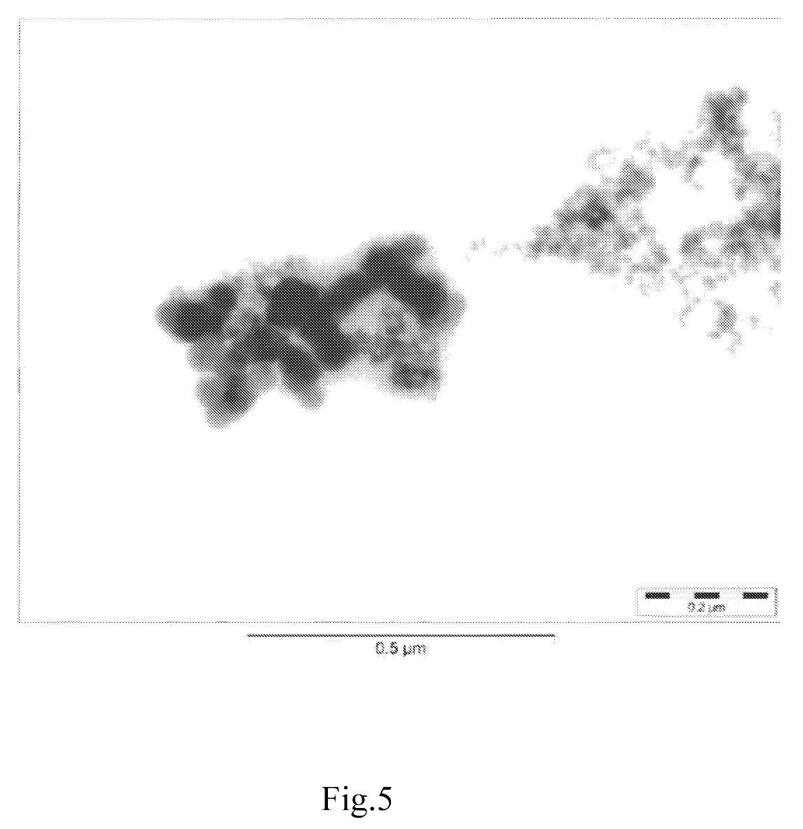

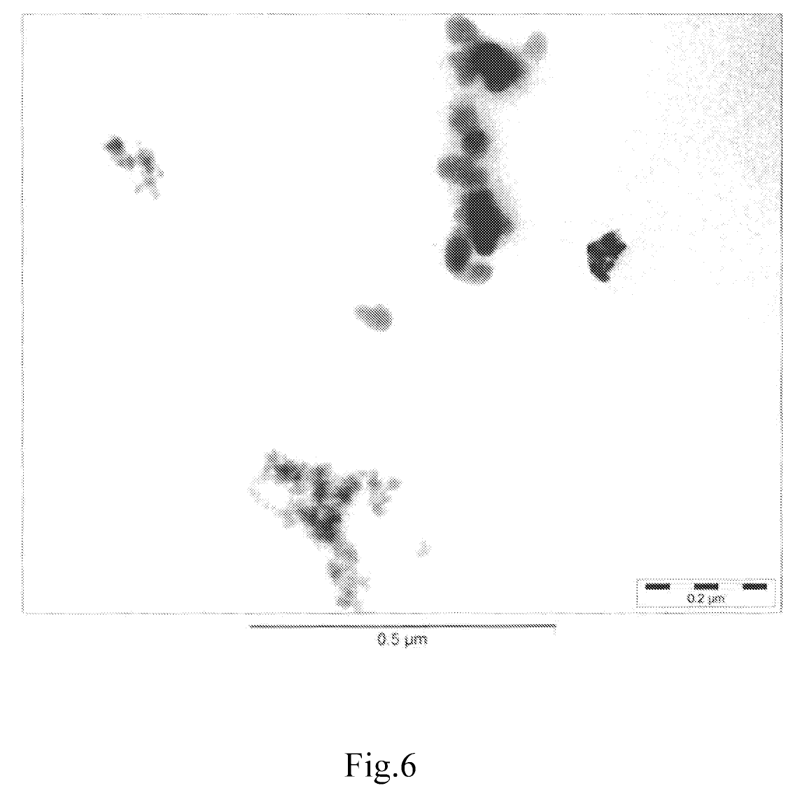

FIGS. 1-3 show X-ray diffraction (XRD) patterns of the products of the embodiments I, II and III in which there are three major peaks from the CIGS nanoparticles or CIS nanoparticles. XRD data are collected by using a Rigaku 18 kW Rotating Anode X-ray Generator. All the peaks in the XRD patterns can be indexed to a tetragonal chalcopyrite structure, the strongest diffraction peak is around 2 theta at about 26.7 degrees corresponds to diffraction from 112 plane, while the other peaks at 2 theta at about 44.35 and 52.7 degrees corresponds to diffraction from (220), (204) and (312) planes. These planes are referred to the CIS/CIGS crystalline lattice. In addition, the products of the above embodiments I, II and III are also prepared for transmission electron microscopy (TEM) characterization. The TEM analysis is performed by using a JEOL JEM-1400 120 kv transmission electron microscope. FIGS. 4-6 show the TEM image of CIGS/CIS nanoparticles generated from the embodiments I, II and III. The scale bar is 200 nm. The average size of the CIGS/CIS nanoparticles is estimated to be 10-200 nm, wherein the shown large size of nanoparticles results from agglomeration in product formation.

As apparent from the foregoing, the method of the present invention is capable of producing an ink composition for forming CIGS film. The chelating agent including aromatic diamine compounds, alkyl diamine compounds and aliphatic diamine compounds easily dissolves the reactant elements or salts, such as selenium and copper, so that the CIGS film can be produced in a simple single-stage process instead of the conventional multiple-stage process which requires alternative vacuum processing or complex equipment.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An ink composition for forming absorbers of thin film cells, comprising:
particles containing a mixture of at least one element or the salts from group IB and/or IIIA and/or VIA; and
a chelating agent for the particles, the chelating agent is selected from the group consisting of aromatic diamine compounds, alkyl diamine compounds and aliphatic diamine compounds.

2. The ink composition of claim 1 further including alcoholic compounds selected from a group consisting of methanol, ethanol, propanol, butanol, and tert-butanol.

3. The ink composition of claim 1, wherein the elements are selected from the group consisting of copper, aluminum, gallium, indium and selenium.

4. The ink composition of claim 1, wherein the salts are selected from CuCl, InCl3, GaCl3, CuBr, InBr3, GaBr3, CuI, InI3 and GaI3.

5. The ink composition of claim 1, wherein the aromatic diamine compounds are selected from the group of phenylenediamine, diaminotoluene, xylenediamine, 2,4-diethyltoluenediamine, 2,6-diethyltoluenediamine diaminonaphthalene, diaminophenanthrene and diaminoanthracene.

6. The ink composition of claim 1, wherein the alkyl diamine compounds are selected from the group of hexanediamine, heptanediamine and octanediamine.

7. The ink composition of claim 1, wherein the aliphatic diamine compounds is isophoronediamine.

8. A method for producing an ink composition for forming absorbers of thin film cells, comprising the steps of:
a) obtaining powders containing a particle mixture of at least one elements or the salts from group IB and/or IIIA and/or VIA;
b) adding a chelating agent into the powders, the chelating agent is selected from the group consisting of aromatic diamine compounds, alkyl diamine compounds and aliphatic diamine compounds; and
c) heating the chelating agent to a first temperature at which the chelating agent is melted, and reacting the melting chelating agent with the powders in an inert gas environment to form solutions.

9. The method of claim 8 further including the steps of:
d) cooling the solutions to a second temperature which is lower than the first temperature and allows the solutions being stirred;
e) mixing the cooled solutions with alcoholic compounds at the second temperature.

10. The method of claim 9, wherein the alcoholic compounds are selected from a group consisting of methanol, ethanol, propanol, butanol, and tert-butanol.

11. The method of claim 8, wherein the elements are selected from the group consisting of copper, aluminum, gallium, indium and selenium.

12. The method of claim 8, wherein the salts are selected from CuCl, InCl3, GaCl3, CuBr, InBr3, GaBr3, CuI, InI3 and GaI3.

13. The method of claim 8, wherein the aromatic diamine compounds are selected from the group of phenylenediamine, diaminotoluene, xylenediamine, 2,4-diethyltoluenediamine, 2,6-diethyltoluenediamine, diaminonaphthalene, diaminophenanthrene and diaminoanthracene.

14. The method of claim 8, wherein the alkyl diamine compounds are selected from the group of hexanediamine, heptanediamine and octanediamine.

15. The method of claim 8, wherein the aliphatic diamine compounds is isophoronediamine.

16. The method of claim 8, wherein the inert gas is selected from nitrogen and argon.
